(19) United States
(12) Patent Application Publication
(10) Pub. No.: US 2019/0292848 A1
(43) Pub. Date: Sep. 26, 2019

(54) DEVICES AND METHODS FOR MANUAL TO MOTORIZED CONVERTIBLE WINDOW ASSEMBLIES

(71) Applicant: TTI (Macao Commercial Offshore) Limited, Macau (MO)

(72) Inventors: J. Porter Whitmire, Greenville, SC (US); Michael Preus, Piedmont, SC (US); Austin Clark, Greenville, SC (US); John Schnell, Anderson, SC (US); Elton Lee Watson, Greenville, SC (US)

(73) Assignee: TTI (Macao Commercial Offshore) Limited, Macau (MO)

(21) Appl. No.: 16/356,763

(22) Filed: Mar. 18, 2019

Related U.S. Application Data
(60) Provisional application No. 62/646,002, filed on Mar. 21, 2018.
(60) Provisional application No. 62/683,297, filed on Jun. 11, 2018.

(51) Int. Cl. E06B 9/70; E06B 9/262; E06B 9/322; E06B 9/74

(52) U.S. Cl. CPC E06B 9/70; E06B 9/262; E06B 2009/2627; E06B 9/74; E06B 9/322

(57) ABSTRACT

A motor module is configured to convert a manually-operable window covering assembly to a motorized window covering assembly. In one embodiment, the motor module includes output shaft that engage with couplers of the window covering assembly that receive a spring module when the assembly is in a manually-operated state. The couplers are displaceable such that the spring module and motor module may be either removed and inserted into the assembly. The motor module is made sufficiently compact to fit in the header by arranging a motor, battery, circuit board, and internal gearing system to efficiently use the space in the motor module. In another embodiment, a motorized converter module is configured to be installed on a manually-operated window covering assembly to convert the window covering assembly from a manually-operated state to a motorized stated without removing any components of the window covering assembly.

This application claims the benefit of U.S. Provisional Application No. 62/646,002, filed Mar. 21, 2018, the contents of which are hereby incorporated by reference in their entirety, and this application claims the benefit of U.S. Provisional Application No. 62/683,297, filed Jun. 11, 2018, the contents of which are hereby incorporated by reference in their entirety.

### SUMMARY

The present subject matter relates to a motor module that may convert a manually-operated window covering assembly to a motorized window covering assembly and methods of such a conversion. In one embodiment, the motor module is configured to be installed in a window covering assembly that includes couplers that receive a spring module when the assembly is in a manually-operated state and a motor module when in the motorized state. The couplers are displaceable such that the spring module and motor module may be either removed and inserted into the assembly. Various arrangements of a motor, battery, and circuit board of the motor module are provided so that these necessary components may reside in a relatively small module that is able to be disposed in a standard header of a window covering assembly.

In another embodiment, the motorized module is configured to engage a manually-operable window covering assembly without the need to remove any of the components of the window assembly. For example, the motorized module may include a transmission with a gear that may have a hole that interfaces with a shaft in a transfer drum of the window assembly. Thereafter, the window covering may be manipulated by the motorized module.

### BRIEF DESCRIPTION OF THE DRAWINGS

FIG. 1 is a perspective view of a window covering assembly in a manually-operated state according to a first embodiment of the present subject matter.

FIG. 2 is a bottom view of a window covering assembly in a manually-operated state according to a first embodiment of the present subject matter.

FIG. 3 is a perspective view of a window covering assembly in a motorized stated according to a first embodiment of the present subject matter.

FIG. 4 is a bottom view of a window covering assembly in a motorized stated according to a first embodiment of the present subject matter.

FIG. 5 is a top layout view of a motor module according to one embodiment of the present subject matter.

FIG. 6 is a side layout view of a motor module according to one embodiment of the present subject matter.

FIG. 7 is a top layout view of a motor module according to one embodiment of the present subject matter.

FIG. 8 is a top layout view of a motor module according to one embodiment of the present subject matter.

FIG. 9 is a top view of a manually-operated window covering assembly according to a second embodiment of the present subject matter.

FIG. 10 is a top view of a motor module according to a second embodiment of the present subject matter.

FIG. 11 is a top view of the motor module shown in FIG. 10 installed on the manually-operated window covering assembly shown in FIG. 9.

FIG. 12 is a perspective view of a manually-operated window covering assembly and motor module according to a third embodiment of the present subject matter.

FIG. 13 is a perspective view of a manually-operated window covering assembly and motor module according to a third embodiment of the present subject matter with a cover of the manually-operated window covering assembly not shown for clarity.

FIG. 14 is a perspective view of a manually-operated window covering assembly and motor module according to a third embodiment of the present subject matter with a cover of the manually-operated window covering assembly and a cover of the motor module not shown for clarity.

### DETAILED DESCRIPTION OF THE PREFERRED EMBODIMENT

Reference will now be made in detail to the preferred embodiments of the present subject matter, which are illustrated in the accompanying drawings.

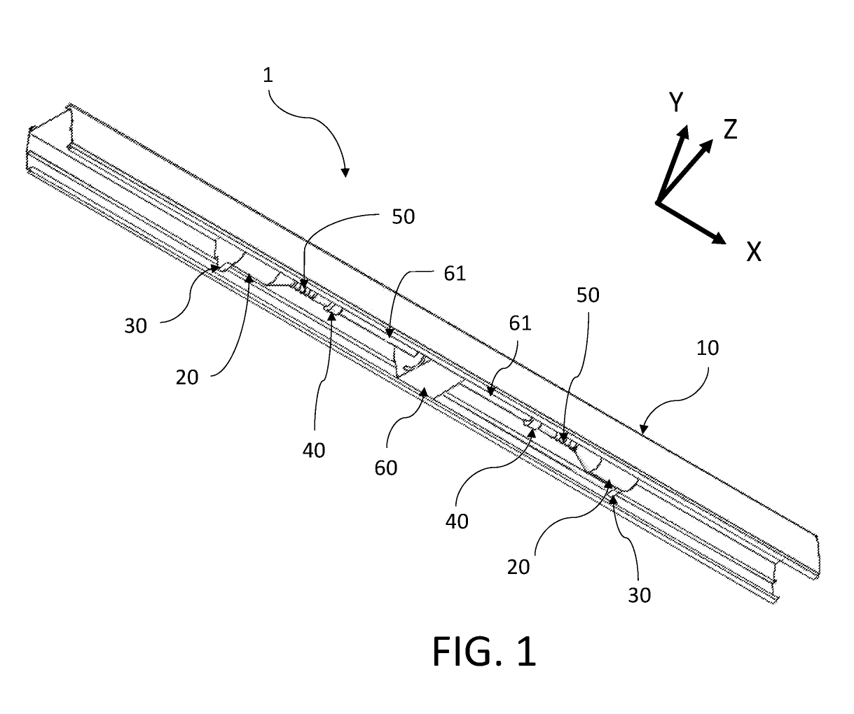

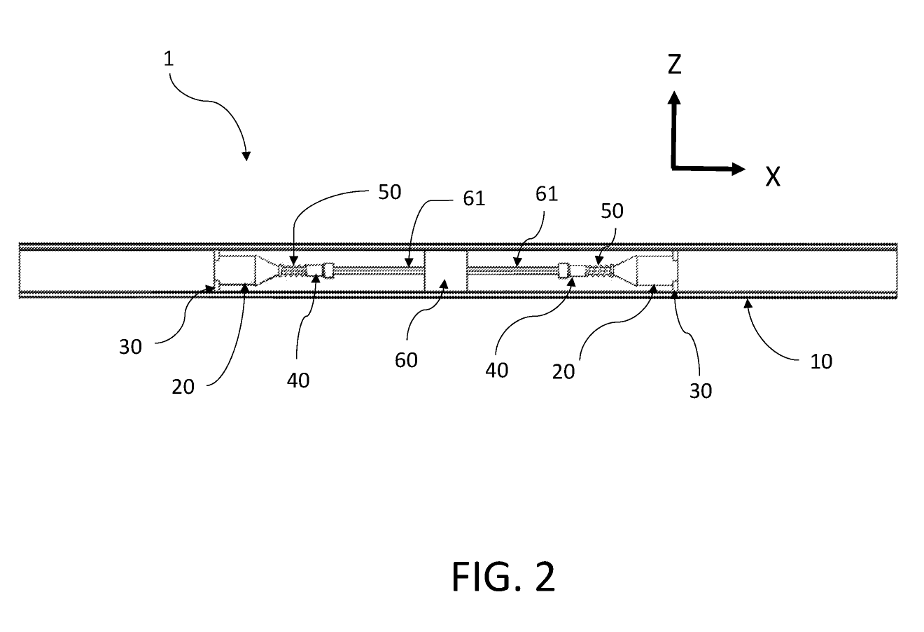

FIGS. 1 and 2 show a window covering assembly 1 in a manually-operated stated according to a first embodiment of the present subject matter. As described herein, the window covering assembly 1 may be converted to a motor-operated stated via insertion of and/or connection to a motorized device, such as a motor module 70. Window covering assembly 1 may include a blinds assembly (e.g., a cellular blinds assembly). The window covering assembly 1 may include a header 10. One or more spools 20 may be provided on, over, and/or within a portion of header 10, and such spools 20 may be received in bearings 30 provided on the outer sides of the spools 20. Near the inner sides of the spools 20, couplers 40 may be provided, which may non-fixedly engage with springs 50. In the illustrated embodiment, springs 50 may be formed as coils and/or coiled springs. Also provided is spring module 60, which includes spring module shafts 61. Spring module shafts 61 are configured to engage with couplers 40. When a user manually extends the window covering (not shown), in the negative (−) Y direction, a spring in the spring module 60 is biased so as to exert a rotational force on spring module shafts 61, and thereby spools 20, to at least partially offset the weight of the window covering. A user may retract the window covering by exerting a force in the positive (+) Y direction. Because the springs in the spring module 60 are biased during the extension of the window covering, the force exerted by the user during retraction may be less than the overall weight of the window covering.

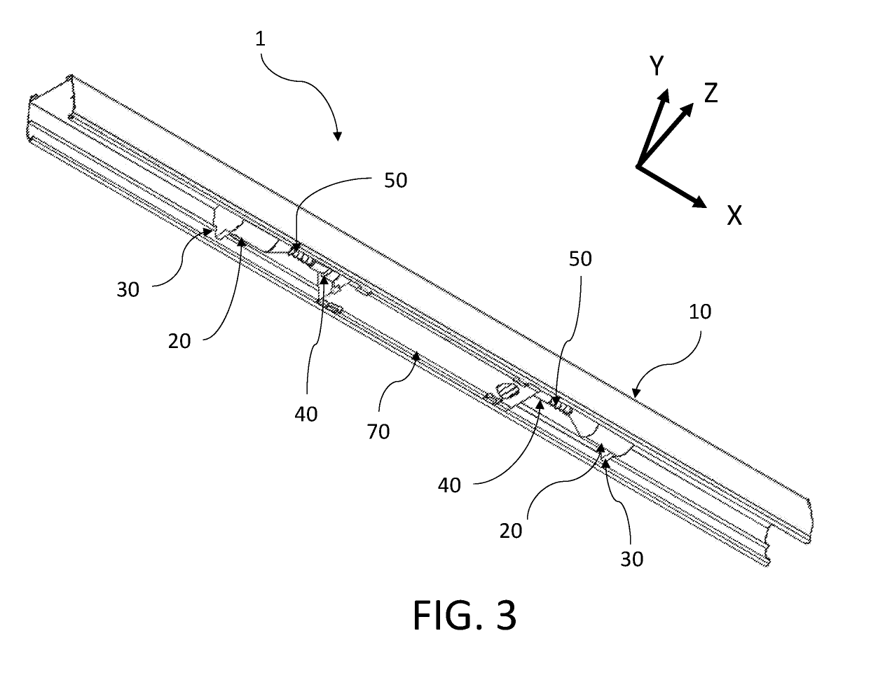

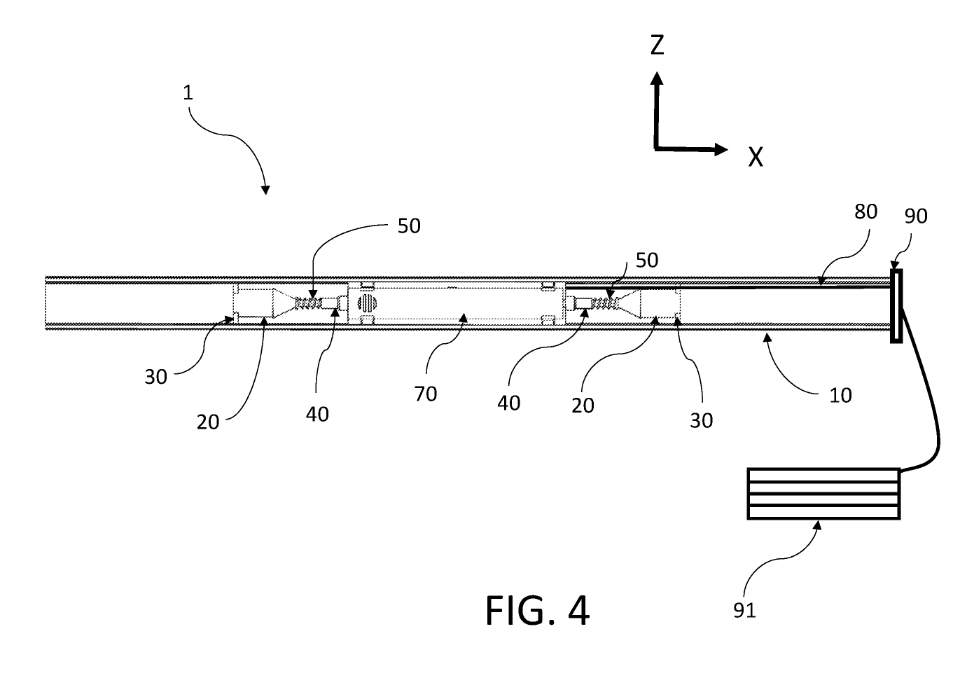

FIGS. 3 and 4 show a window covering assembly 1 in a motorized state according to a first embodiment of the present subject matter. Many of the same components as are present in the manually-operated state may also be present in the motorized state, in particular header 10, spools 20, bearings 30, couplers 40, and/or springs 50. In FIGS. 3 and 4, the same reference numerals as are used in FIGS. 1 and 2 are used to refer to these components.

In the motorized state, motor module 70 is provided. Motor module 70 may be integrated with header 10 of window covering assembly 1 or motor module 70 may be a discrete component (e.g., separate from window covering assembly 1) that is configured for insertion within header 10 of window covering assembly 1. Motor module 70 may be a motorized device that includes at least one output member such as output shafts (described later) that are configured to engage and/or interface with couplers 40. The output shafts may rotate and couplers 40 may likewise rotate, thereby causing spools 20 to rotate to extend and/or retract the window covering by way of a motor. In this way, motor module 70 may automate the extension and/or retraction of the window covering and, thus, improve the ease of operation and control of window covering assembly 1. Additionally, or alternatively, motor module 70 may cause or induce the rotation of blind members forming the window cover of window covering assembly 1, thus, automating the opening and/or closing of the blind members respective to a window. As is shown in FIG. 4, in the illustrated embodiment, an electrically conductive power wire 80 may be routed between and/or from motor module 70 to an endcap 90 (not shown in FIG. 3). Endcap 90 may include one or more connection points for connection with (e.g., electrically charging and attaching to) a solar accessory 91.

Conversion between the manually-operated state shown in FIGS. 1 and 2 and the motorized state in FIGS. 3 and 4 may be achieved as described herein. In one embodiment, couplers 40 may be displaced away from the spring module 60, for example, and be moved in the +X direction for the coupler 40 on the right in FIGS. 2 and 4 and in the −X direction for the coupler 40 on the left in FIGS. 2 and 4. This displacement may cause springs 50 to compress. Upon displacing couplers 40 to a degree sufficient to disengage the spring module shafts 61 from couplers 40, spring module 60 may be removed (i.e., physically removed) from the header 10 in the −Y direction. (In FIGS. 2 and 4, the −Y direction is out of the page.) The motor module 70 may be inserted in the header 10 by way of displacing the couplers 40 outward, for example, in the +X direction for the coupler 40 on the right in FIGS. 2 and 4 and in the −X direction for the coupler on the left in FIGS. 2 and 4. In this way, motor module 70 may replace spring module 60 so that the window covering of window covering assembly 1 may be operated and/or controlled by way of motor assembly 70. Upon displacing couplers 40 to a sufficient degree to allow insertion of motor module 70, motor module 70 may be positioned in header 10 in the +Y direction. (In FIGS. 2 and 4, the +Y direction is into the page.) Upon insertion of motor module 70 in header 10, the compressive force(s) acting to displace couplers 40 may be removed. Upon removal of the force(s), springs 50 may decompress and move the couplers 40 into engagement with motor module 70 and, thus, retain motor module 70 within housing 10. The power wire 80 may connect motor module 70 and end cap 90, which is placed on one end of the header 10. Power wire 80 may be routed from the motor module 70 after the motor module 70 is inserted in header 10, or power wire 80 may be routed from motor module 70 prior to insertion of motor module 70 into header 10. As noted above, end cap 90 may be provided with connection points for charging a battery in motor module 70 and attaching a solar accessory 91.

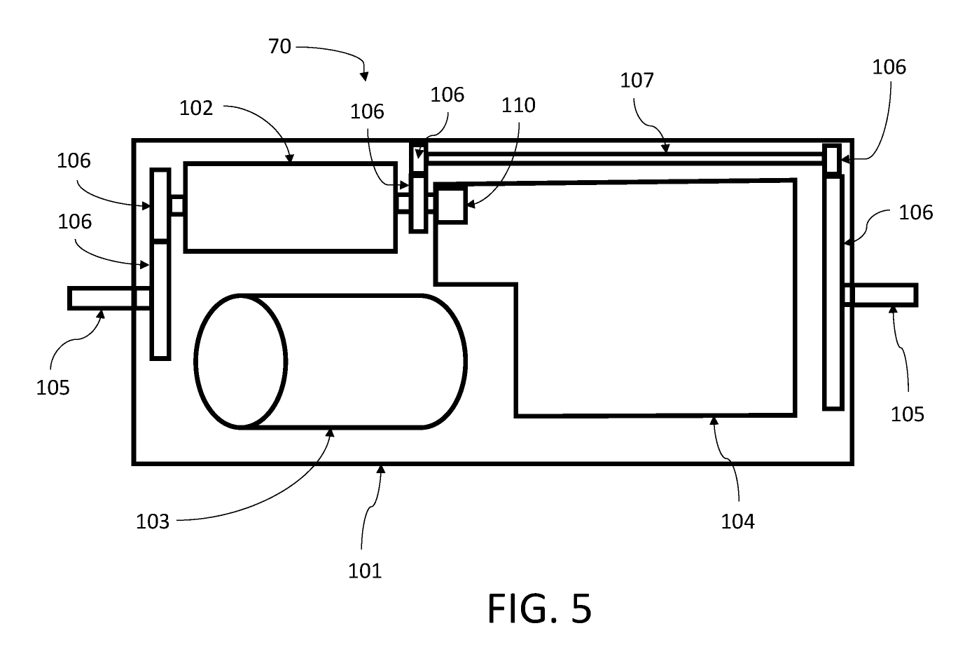

FIGS. 5-8 show various arrangements of components of motor module 70 in accordance with certain embodiments of the present subject matter. Referring to FIGS. 5-7, and in some embodiments, the motor module 70 may include a housing 101, a motor 102, a battery 103, and a circuit board 104. In some embodiments, motor 102 is powered by battery 103, which may be electrically coupled to motor 102 via wires, circuits, and/or the like, and motor 102 is controlled by circuit board 104 and/or components (e.g., hardware circuitry and/or software components) disposed on and/or in electrical connection with circuit board 104. For example, circuit board 104 may support (e.g., physically support, electrically support, and/or the like) a processor component, such as a microcontroller, a digital signal processor (DSP), a system on a chip (SoC), an integrated circuit (IC), control circuitry, and/or the like, which is configured to control the motor 102 for inducing or causing the extension, retraction, and/or other movement of the window covering portion (e.g., blinds) of window covering assembly 1. Such control may be implemented by way of the processor component reading and executing software instructions stored in a memory component (e.g., a non-transitory memory device such as a RAM, a ROM, a flash memory, an optical memory, and/or the like) of the circuit board 104, which is in electrical communication with the processor component. When executed, the software instructions stored in the memory component may cause the processor component to perform one or more processes described herein. Additionally, or alternatively, hardwired circuitry may be used in place of or in combination with software instructions to perform one or more processes described herein. Thus, the embodiments described herein are not limited to any specific combination of hardware circuitry and software.

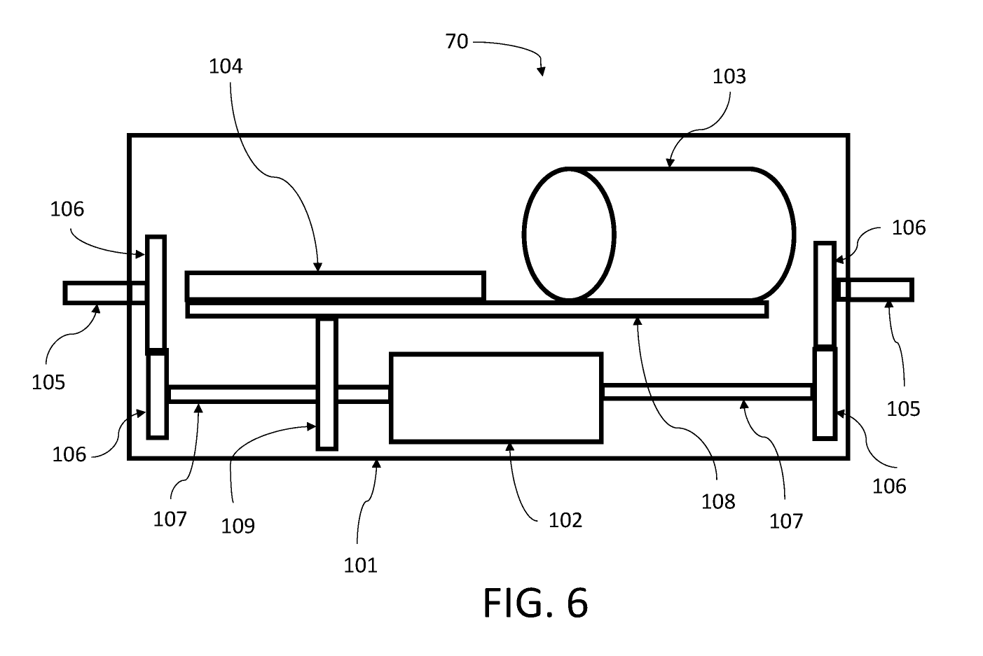

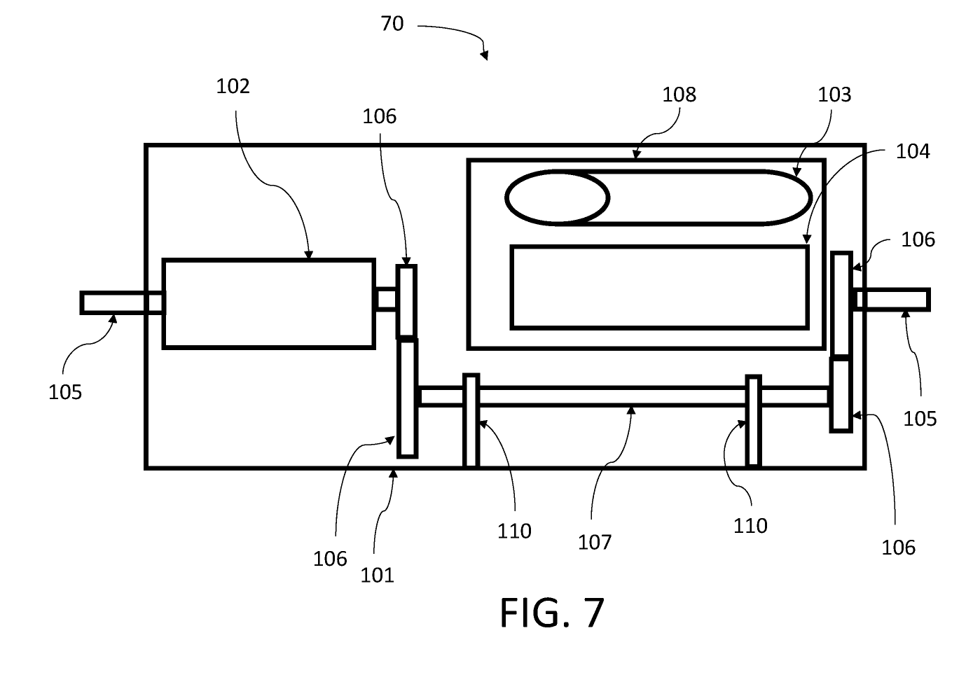

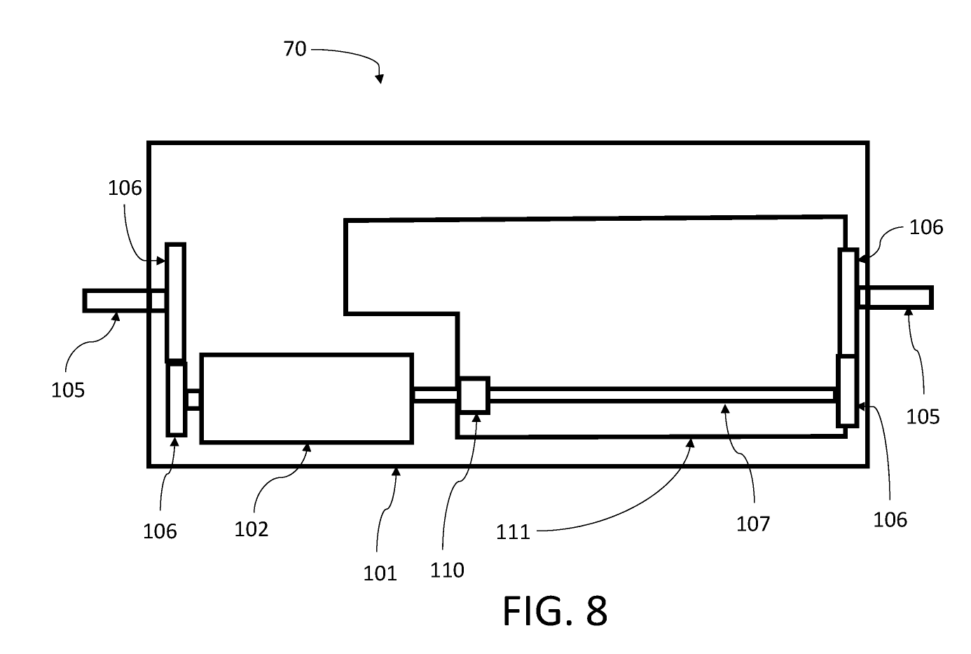

In some embodiments, motor 102 may be configured to power one or more output members, such as shafts 105 (e.g., output shafts), disposed on either end of the motor module 70, either directly or indirectly by way of one or more actuating components, such as one or more gears 106 and/or internal shafts 107. Output shafts 105 may be connected (e.g., directly or indirectly connected) to a window covering, which may be extended or retracted respective to the header 10 (FIG. 4) via power supplied by motor 102. Gears 106 may be spur gears. In some embodiments, a platform 108 may be provided to support some of the components. For example, as illustrated in FIG. 6, battery 103 and circuit board 104 are supported by platform 108 above motor 102. In this embodiment, platform 108 is supported by one or more platform supports 109. In some embodiments, bearing supports 110 (FIG. 7) are provided for supporting, for example, internal shafts 107. For example, in FIG. 7, bearing supports 110 are provided for supporting internal shaft 107. In some embodiments, battery 103 and circuit board 104 can be formed or provided as discrete components. In some embodiments, battery 103 and circuit board 104 can be formed or provided a single, unitary component. For example, as illustrated in FIG. 8, a unitary battery-circuit board 111 may be provided. Otherwise, the embodiment shown in FIG. 8 includes many of the same components as shown in FIGS. 5-7 and such components are referenced by way of the same reference numerals as are used in FIGS. 5-7.

By way of the arrangements of the components, a compact motor assembly 70 may be achieved such that motor assembly 70 may be inserted into header 10 for operating and/or controlling aspects of window covering assembly 1.

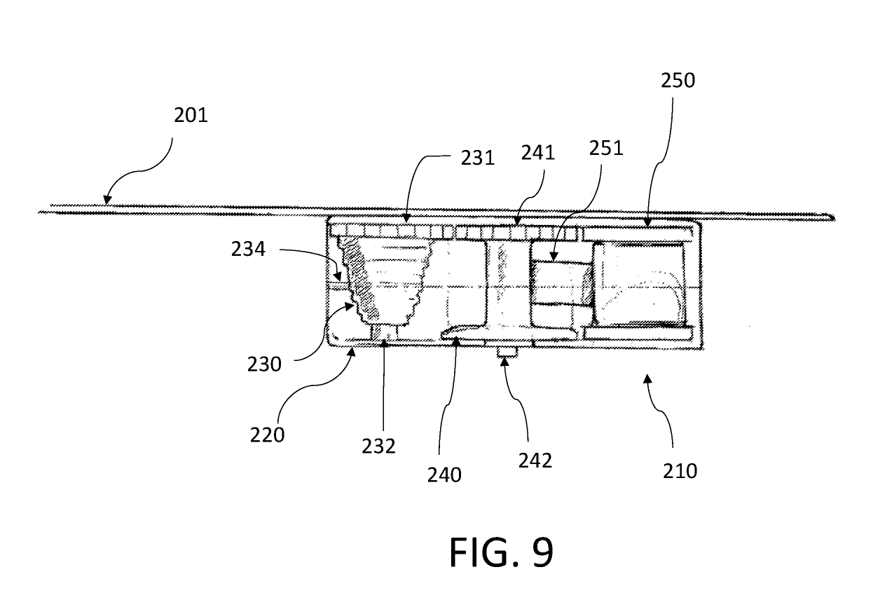

FIG. 9 shows a manually-operated window covering assembly 210 according to a second embodiment of the present subject matter. Assembly 210 may be disposed in a window covering header 201, to which a window covering (not shown) may be suspended. An example window covering may include blinds. The manually-operated window covering assembly 210 may include a housing 220, in which may be disposed a cord spool 230, a transfer drum 240, and/or a coil spring drum 250.

Cord spool 230 may include a spur gear 231 at one end, and one end of a cord 234 may be would around cord spool 230. The other end of cord 234 may be attached to the window covering. Cord spool 230 may be provided with a shaft 232 around which cord spool 230 rotates. Shaft 232 may be fixedly attached to housing 220, in some embodiments.

Transfer drum 240 may be provided with a spur gear 241 on one end. In one embodiment, cord spool 230 and transfer drum 240 are arranged such that spur gear 231 of cord spool 230 engages spur gear 241 of transfer drum 240. Transfer drum 240 may also include a shaft 242 that rotates with the transfer drum 240.

Coil spring drum 250 may be disposed on a side of the transfer drum 240 opposite the side on which the cord spool 230 is disposed. One end of a coil spring 251 may be wound around coil spring drum 250. The other end of coil spring 251 may be attached to transfer drum 240.

Operation of the window covering by way of the manually-operated assembly 210 will now be described. A user may raise or lower a window covering, for example blinds, by direct manual manipulation of the window covering. For example, if the window covering is in a raised position, the user may pull down on the window covering. When this operation is performed, cord 234 may unwind from cord spool 230, which causes cord spool 230 to rotate on and/or around shaft 232. Such rotation causes or induces a rotation of spur gear 231, which may in turn cause or induce a rotation of spur gear 241. Because drum 240 is attached to spur gear 241, spur gear 241 and transfer drum 240 may simultaneously co-rotate respective to parallel axes. When transfer drum 240 rotates, it causes the unwinding and energizing of coil spring 251 from coil spring drum 250. In an energized state, coil spring 251 is configured to exert a torque on transfer drum 240 in a direction opposite that in which transfer drum 240 rotated during the foregoing operation. However, the torque exerted by coil spring 251 may not be large enough to overcome the torque imparted on transfer drum 240 by the weight of the window covering. In particular, the weight of the window covering pulls on cord 234, thereby imparting a torque on cord spool 230, which, by way of spur gears 231 and 241, exerts a torque on transfer drum 240. However, the torque on transfer drum 240 exerted by coil spring 251 reduces the force required to raise the window covering, as explained below.

In some embodiments, a user may raise a window covering by pushing up on the window covering. This may reduce the torque imparted on transfer drum 240 by the weight of the window covering. When the force imparted by the user is sufficiently great, the torque imparted by coil spring 251 is greater than the torque (in an opposite direction) imparted by the weight of the window covering. Thus, transfer drum 241 may be caused to rotate. Due to the interaction of spur gears 231 and 241, cord spool 230 may rotate around shaft 232, thereby causing cord 234 to become wound around cord spool 230. The rotation of transfer drum 241 may also cause the unwinding of coil spring 251 from transfer drum 241 and the winding of coil spring 251 around coil spring drum 250.

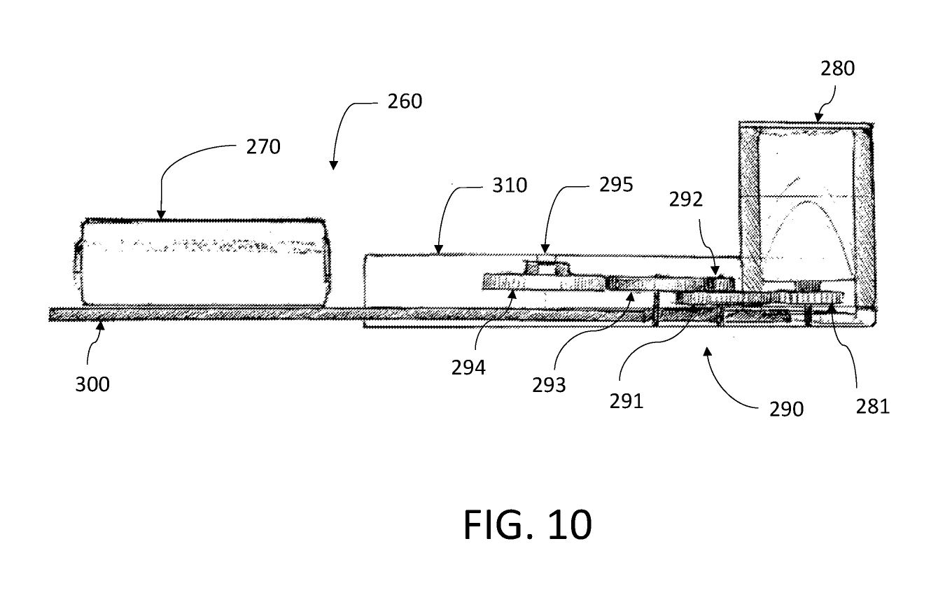

FIG. 10 shows a motor module 260 in accordance with one embodiment of the present subject matter. In some embodiments, motor module 260 is a motorized converter module by which a window covering may be converted from a manually operated window covering to a motorized (i.e., motor operated) window covering. Motor module 260 may include a battery 270 (e.g., a rechargeable battery, a non-rechargeable battery, and/or the like), a motor 280, and a transmission assembly 290. These components may be supported by one or more supports, such as supports 300 and 310.

Motor 280 may be provided with a pinion 281 that rotates upon operation of motor 280 and that may physically and mechanically couple motor 280 to a transmission assembly 290. Motor 280 may include a compact electric motor, in some embodiments, that is powered by way of battery 270, which may be electrically coupled to motor 280 via wires, circuits, and/or the like.

Transmission assembly 290 may comprise a series of reducers and/or actuators, such as a series of gears, for example comprising spur gears 291, 292, 293, and 294. The series of gears may collectively cause a reduction of motor speed and/or rotation from the pinion 281 to gear 294. In the illustrated embodiment, gear 294 includes an output member, such as opening or hole 295. Motor 280 and transmission assembly 290 may be physically and mechanically coupled by structure different from pinion 281, for example by a belt and pulley system, a chain and sprocket system, and/or the like.

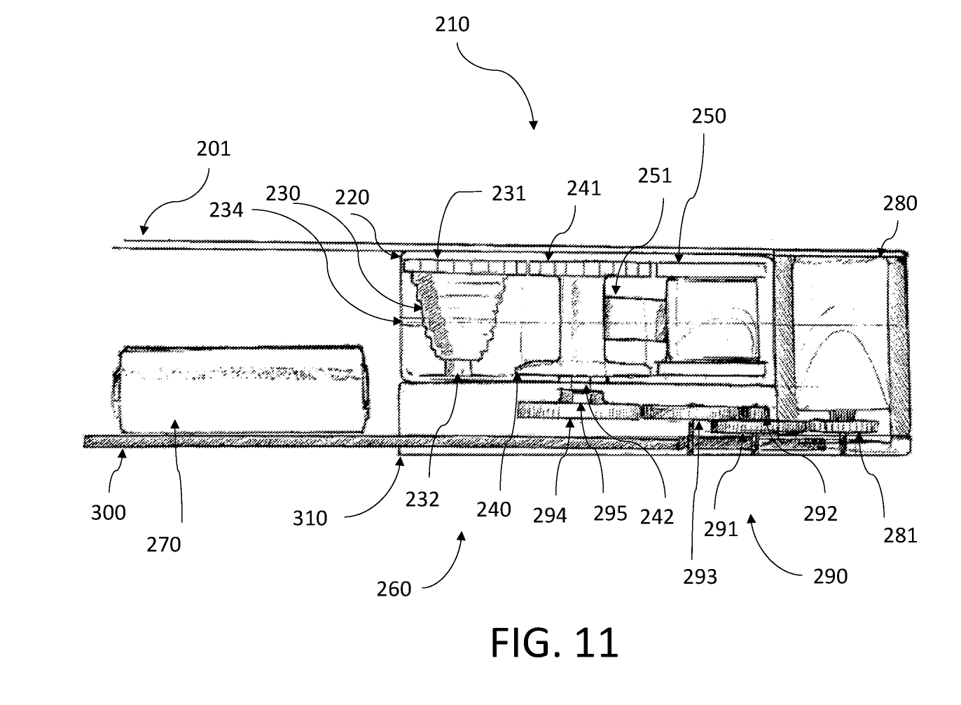

FIG. 11 shows the motor module 260 as installed in, on, and/or over the manually-operated window covering assembly 210. In this way, motor module 260 may be used to convert the window covering assembly 210 from being manually operable to being motorized and, thus, electrically operable. The motor module 260 is configured to be installed on the manually-operated window covering assembly 210 without the need for the removal of any parts of the assembly 210 or otherwise result in any significant alterations to the assembly 210 and/or header 201. For example, the hole 295 of the gear 294 is configured to receive the shaft 242 of transfer drum 240 to facilitate an easy and efficient installation of the motor module 260 respective to assembly 210.

The other components of the motorized module 260 are configured to be disposed within header 201 when installed on the manually-operated window covering assembly 210.

Operation of the motor module 260 will now be described. A user may raise or lower the window covering via activating motor 280. Motor 280 may be activated by way of causing power to energize the motor via actuating a switch, a trigger, instructions from a control (e.g., remote control), and/or the like. In particular, when a user desires to lower the window covering, the user may activate motor 280 to rotate in a first direction. This may cause, via transmission 290, and the interface between hole 295 of gear 294 and shaft 242 of transfer drum 240, transfer drum 240 to rotate in a direction associated with the lowering of the window covering. When transfer drum 240 rotates in this direction, it causes cord spool 231 to rotate in a direction associated with the lowering of cord 234, which causes the lowering of the window covering. As with the exemplary embodiment discussed above, when the motor module 260 is installed, the window covering may be blinds. At the same time, rotation of transfer drum 240 may cause part of coil spring 251 to become unwound from coil spring drum 250 and be wound onto transfer drum 241. As with the embodiment described above, coil spring 251 may exert a torque on transfer drum 241, but not enough to overcome the weight of the window covering.

When a user desires to raise the window covering, the user may activate motor 280 to rotate in a second direction, opposite the first direction. This may cause, via transmission 290, and the interface between hole 295 of gear 294 and shaft 242 of transfer drum 240, transfer drum 240 to rotate in a direction associated with the raising of the window covering. The torque imparted by coil spring 251 may assist in the rotation of transfer drum 240. As transfer drum 240 rotates, it causes, via the interaction of gears 231 and 241, cord spool 230 to rotate about shaft 232 and take up cord 234. This raises the window covering to which cord 234 is attached.

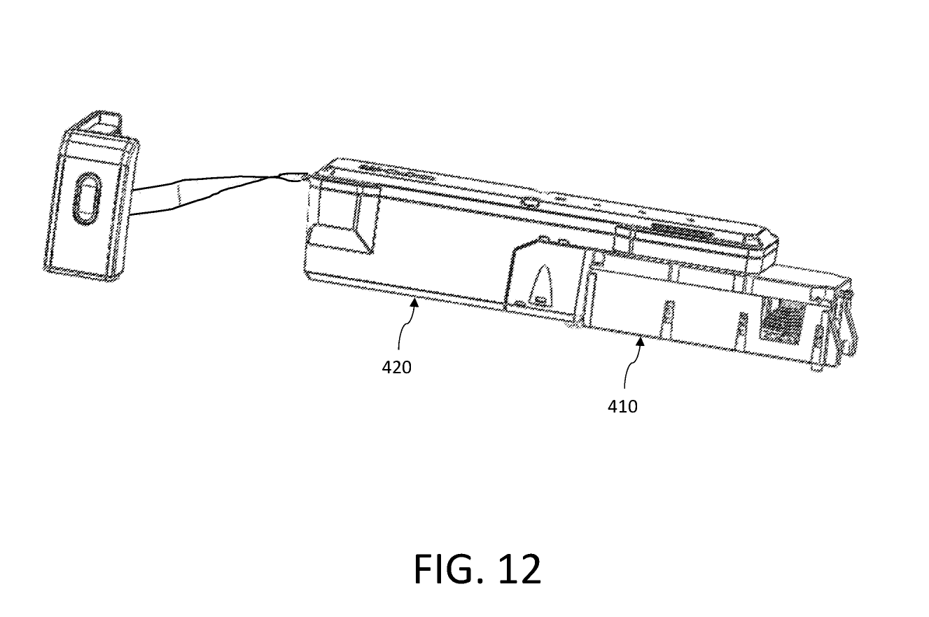

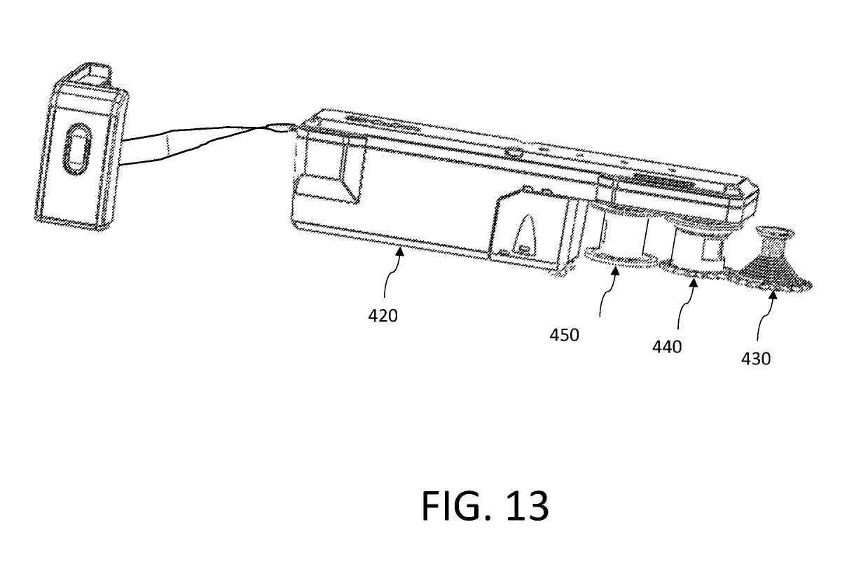

FIG. 12 shows a manually-operated window covering assembly 410 to which is coupled a motor module 420 according to a third embodiment of the present subject matter. Motor module 420 may include and/or form a housing for at least partially covering a motor as described herein, the motor being configured to induce movement of a window cover of window assembly 410. FIG. 13 shows the assembly 410 with its cover not shown for clarity. As shown in FIG. 13, manually-operated assembly 410 includes cord spool 430, a transfer drum 440, and a coil spring drum 450, similar to the embodiment shown in FIG. 9.

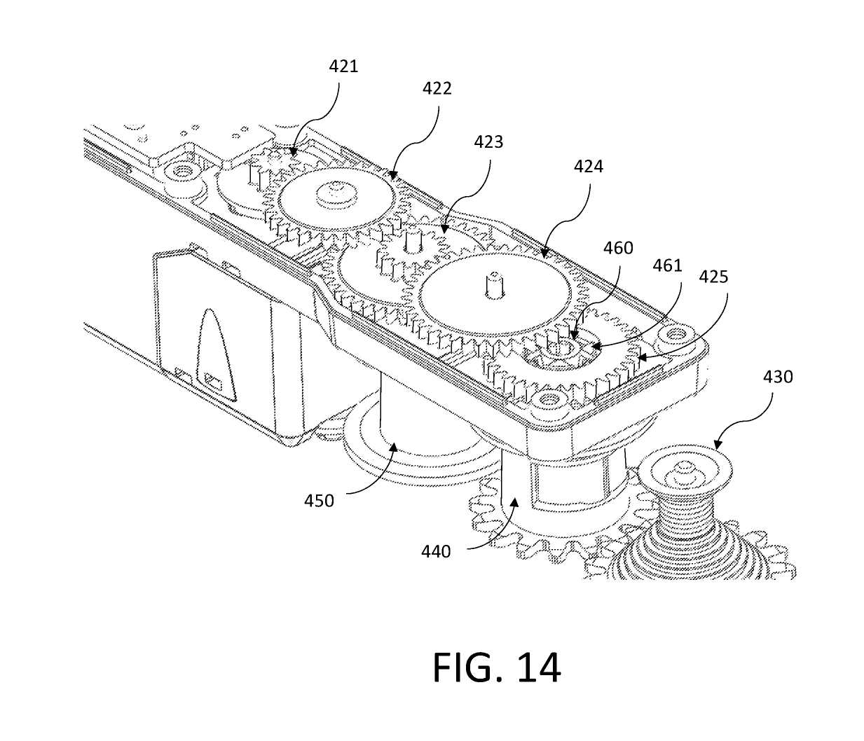

In some embodiments, window covering assembly 410 is provided with a slip clutch to, for example, prevent excessive torque imparted by manually operating the blinds from being transferred to the motor of motor module 420. FIG. 14 shows an exemplary slip clutch. FIG. 14 shows motor module 420 with its top not shown for clarity. As shown in FIG. 14, in one embodiment, motor module 420 includes a gear 425 that is driven by a motor (not shown) via a pinion 421 and gears 422-424 of a gear train. Pinion 421 may physically and mechanically couple motor (not shown) with gears 422-424 of a gear train. Alternatively, a belt and pulley system, a chain and sprocket system, and/or the like may be used. Gear 425 interfaces with transfer drum 440 via an output member, such as a connector 460 that includes flanges 461. Flanges 461 fit in the space created by the inside diameter of gear 425. The interface between the flanges 461 and gear 425 is a friction fit. During low-torque operations, the friction force is sufficient to transmit the torque between the gear 425 and transfer drum 440 via connector 460, and both gear 425 and transfer drum 440 rotate in unison. During high-torque operations, the friction force is overcome, and one of the gear 425 and transfer drum 440 may rotate while the other remains stationary. In this way, flanges 461 and gear 425, collectively, operate as a slip clutch.

It will be apparent to those skilled in the art that various modifications and variations can be made in the manual to motorized convertible blinds of the present subject matter. Thus, it is intended that the present subject matter covers modifications and variations of this subject matter provided within the scope of the appended claims and equivalents of the appended claims.

What is claimed is:

1. A motor module configured for insertion in a portion of a window assembly, the motor module comprising:
a housing;
a motor disposed in a portion of the housing;
a battery coupled to the motor;
a transmission coupled to the motor; and
an output member coupled to the transmission and extending from the housing,
wherein the output member is configured to cause a window cover to move respective to the housing.

2. The motor module of claim 1, wherein the housing is fully insertable within a header of the window covering assembly.

3. The motor module of claim 1, wherein the battery is a rechargeable battery.

4. The motor module of claim 3 further comprising a solar accessory, the solar accessory being configured to re-charge the rechargeable battery.

5. The motor module of claim 1, wherein the output member comprises an output shaft.

6. The motor module of claim 5, wherein the output shaft is coupled to a transfer drum of the window assembly.

7. The motor module of claim 5, wherein the output shaft comprises a flanged connector.

8. The motor of claim 7, wherein a flange of the flanged connector is connected to a transfer drum of the window assembly via a friction fit, such that a torque is transmitted to the transfer drum when in a motorized state, and the torque is not transmitted to the transfer drum when in a non-motorized state.

9. The motor module of claim 1, wherein the output member is configured to cause a window cover to extend or retract respective to the housing.

10. The motor module of claim 1, wherein the window cover comprises cellular blinds.

11. A method comprising:
disposing a motor module in a portion of a window assembly, the motor module comprising:
a housing;
a motor disposed in a portion of the housing;
a battery coupled to the motor;
a transmission coupled to the motor; and
an output member coupled to the transmission and extending from the housing; and
actuating the output member to cause a window cover of the window assembly to move respective to the housing.

12. The method of claim 11, further comprising the step of fully disposing the motor module in a header of the window assembly.

13. The method of claim 11, wherein the battery is a rechargeable battery.

14. The method of claim 13, further comprising the step of electrically connecting a solar accessory to the rechargeable battery.

15. The method of claim 11, wherein the output member comprises an output shaft.

16. The method of claim 15, further comprising the step of coupling the output shaft to a transfer drum of the window assembly.

17. The method of claim 15, wherein the output shaft comprises a flanged connector.

18. The method of claim 17, further comprising the step of connecting a flange of the flanged connector to a transfer drum of the window assembly via a friction fit, such that a torque is transmitted to the transfer drum when in a motorized state, and the torque is not transmitted to the transfer drum when in a non-motorized state.

19. The method of claim 11, wherein the output member comprises a hole in a gear of the transmission.

20. The method of claim 11, wherein the window cover comprises cellular blinds.
